(19) United States
(12) Patent Application Publication
(10) Pub. No.: US 2001/0029900 A1
(43) Pub. Date: Oct. 18, 2001

(54) Device for holding objects to be observed

(76) Inventor: Terry J. Weber, Adell, WI (US)

Correspondence Address: Steven C. Becker, FOLEY & LARDNER, Firstar Center, 777 East Wisconsin Avenue, Milwaukee, WI, 53202-5367, US

(21) Appl. No.: 09/757,910

(22) Filed: Jan. 10, 2001

Related U.S. Application Data
(60) Provisional application No. 60/176,259, filed on Jan. 14, 2000.

(51) Int. Cl. A01K 31/07

(52) U.S. Cl. 119/453

(57) ABSTRACT

A device for holding objects to be observed includes a frame, a ferrous mesh, a fastener, and a non-ferrous, protective molding. The frame and ferrous mesh form respective portions of an enclosure. The ferrous mesh has an edge coupled to the frame. The fastener is configured to couple the edge to the frame. The non-ferrous, protective molding extends over the edge and is positioned to conceal at least a portion of the edge.

### CROSS-REFERENCE TO RELATED APPLICATIONS

Not Applicable.

### STATEMENT REGARDING FEDERALLY SPONSORED RESEARCH OR DEVELOPMENT

Not Applicable

### FIELD OF THE INVENTION

The present invention relates generally to the field of devices for holding objects to be observed. More specifically, the present invention relates to the field of devices having a mesh screen through which objects may be observed.

### BACKGROUND OF THE INVENTION

In the field of devices for holding objects to be observed, such devices require a frame and at least one wall comprising a transparent material, such as, mesh, plastic or glass. Of these translucent materials, mesh has proven widely popular, particularly in the areas of pets, science, and childrens' toys.

One challenge in designing such a device is using a suitable mesh which is both strong and translucent. For example, some non-ferrous meshes, such as plastic and polymer meshes, can be eaten through by some larger insects. Mesh made from ferrous materials (e.g., wire mesh) is stronger than plastic and polymer meshes, and has been used in the construction of cages and collecting/observing boxes. In these applications, the ferrous mesh has been attached to the frame in various ways. The ferrous mesh has been molded integral with the frame, soldered or welded onto the frame, rolled into a channel or groove in the frame and retained therein by a bead or spline, or nailed or stapled to the frame.

Although nailing or stapling the edges of the ferrous mesh to the frame is a popular attachment method, this method leaves sharp, pointed, or jagged edges of the wire mesh exposed. Prior designs have included thin strips of wood, leather or fabric to cover these jagged edges, the thin strips being nailed and/or stapled to the frame at multiple locations to hold the strips in place and conceal the jagged edges underneath.

These prior designs, however, have inevitable drawbacks. For example, leather and fabric, due to their pliable nature, are only effective at covering the portions of the jagged edge near the nails and/or staples. The remaining portions of the jagged edge can be exposed since the leather or fabric can easily be pulled up or off to the side. Using additional nails and/or staples increases manufacturing costs and negatively affects the cosmetics of the enclosure due to the appearance of having so many exposed nails or staples.

Wood, while stiffer than leather and fabric, is less likely to be pulled away to expose the jagged edge, but has other functional and cosmetic limitations. Wood does not conform easily to curves or bends in the frame, thereby causing stress points and fractures in the wood which eventually lead to cracking and exposure of the jagged edges. Thus, prior designs have failed to realize a device having a structure suitable for use by children, appealing to the consumer, and structurally sound.

Accordingly, what is needed is an improved device for holding objects to be observed. The improved device would reliably cover the jagged edges of a mesh which are coupled to a frame. The improved device would also be more aesthetically and cosmetically appealing to the consumer. The improved device would also be structurally sound and suitable for use by children.

The teachings hereinbelow extend to those embodiments which fall within the scope of the appended claims, regardless of whether they accomplish one or more of the above-mentioned needs.

### SUMMARY OF THE INVENTION

According to an exemplary embodiment, a device for holding objects to be observed is disclosed, having a frame, a ferrous mesh, a fastener, and a non-ferrous, protective molding. The frame and ferrous mesh form respective portions of an enclosure. The ferrous mesh has an edge coupled to the frame. The fastener is configured to couple the edge to the frame. The non-ferrous, protective molding extends over the edge and is positioned to conceal at least a portion of the edge.

According to another exemplary embodiment, a device for holding objects to be observed includes a frame, a mesh, a fastener, and a non-ferrous, protective molding. The frame and mesh define portions of an enclosure, and the mesh has a jagged edge. The fastener is configured to couple the jagged edge to the frame. The protective molding extends over at least a portion of the jagged edge.

According to yet another exemplary embodiment, a method of providing a device for holding objects to be observed includes: providing a frame; fastening a first edge of a mesh material to a first portion of the frame; fastening a second edge of the mesh material to a second portion of the frame, wherein the mesh material is securely fastened to the frame; and providing a non-ferrous molding over the first edge of the mesh material.

According to still another exemplary embodiment, a device for holding objects to be observed includes first means for forming a portion of an enclosure; mesh means for forming another portion of the enclosure; means for coupling the mesh means to the first means; and means for concealing at least a portion of the means for coupling.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a perspective view of a device for holding objects to be observed, according to an exemplary embodiment;

FIG. 2 is a partial view of a portion of the device of FIG. 1;

FIG. 3 is a perspective view of a device for holding objects to be observed, according to an alternative embodiment;

FIG. 4 is partial view of a portion of the device of FIG. 4;

FIG. 5 is a partial view of a portion of the device of FIG. 4, according to an alternative embodiment; and

FIG. 6 is a partial view of other alternative configurations of the non-ferrous, protective molding.

### DETAILED DESCRIPTION OF EXEMPLARY EMBODIMENTS

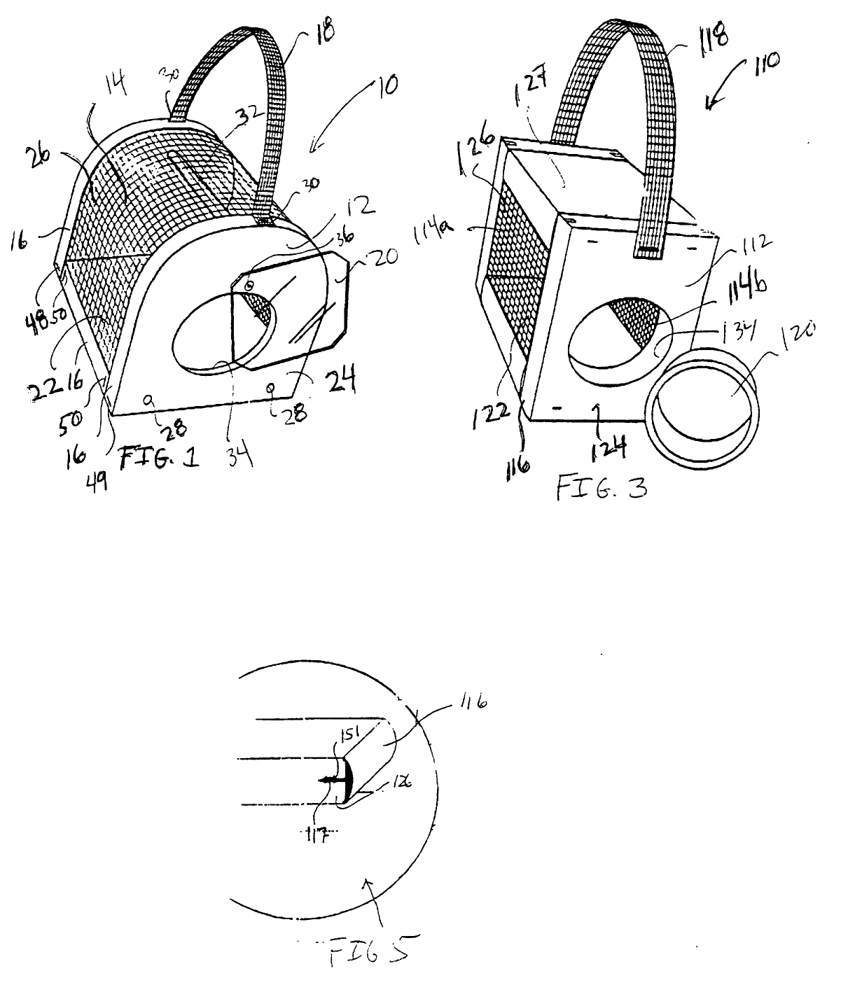

Referring to FIG. 1, a device 10 according to an exemplary embodiment is shown. Device 10 includes a frame 12, a mesh 14, and several non-ferrous, protective moldings 16. Device 10 is suitable for holding objects (e.g., insects, animals, plants, etc.) to be observed and/or housed and is suitable for use in science, for pets, or as a child's toy. Device 10 may be a cage, collecting box, observing box, etc. Device 10 is of a suitable size and weight to be easily handled by a small child. Naturally, the principles disclosed herein are applicable to many other fields, including embodiments which do not include enclosures, such as, ventilation panels, door and window screens, etc.

Frame 12 forms a portion of an enclosure and mesh 14 forms another portion of the enclosure. A door 20 forms the remainder of the enclosure in this exemplary embodiment. While the enclosure is an elongated tunnel shape in this exemplary embodiment, the enclosure may alternatively be square, rectangular, cubic, circular, etc. Frame 12 includes a base wall 22, a front wall 24, and a rear wall 26. Walls 22-26 are made from wood, but may alternatively be made from any hard or pliable substance, including various plastics, polymers, and metals. Front and rear walls each have a height and width of approximately 4 to 12 inches, or preferably less than 24 inches, in order to provide a size suitable for easily being carried by a grown adult or small child. Front and rear walls 24, 26 are coupled to base wall 22 with suitable fasteners 28, such as, wooden dowels and/or glue, nails, screws, welds, etc. A hanging or holding strap 18 made of any suitable material (e.g., a woven cloth ribbon in this exemplary embodiment) is optionally included, and is fastened via suitable fasteners 30 (e.g., nails, staples, glue, etc.) to frame 12 or mesh 14. Also, a rod 32 extends from front wall 24 to rear wall 26 and functions to provide support to device 10 and further as a place for the objects to be observed to roam. Front and rear walls 24, 26 are “U”-shaped in this embodiment, but may alternatively be square, oval, or any other shape. Frame 12 may alternatively include more or less than three walls.

Door 20 covers an aperture 34 (e.g., a circular aperture) in front wall 24. Thus, objects may be moved in and out of device 10 at aperture 34 by rotating door 20 on hinge 36 (e.g., a single screw in this exemplary embodiment) to expose all or a portion of aperture 34. Aperture may have a diameter of between one and five inches, to provide a suitable entry-way for small objects to be observed, such as, insects, frogs, etc. Door 20 is transparent in this embodiment.

Mesh 14, as mentioned, forms a portion of the enclosure. In this exemplary embodiment, mesh 14 is a wire mesh and, more particularly, a ferrous mesh being fabricated from any suitable metals (e.g., steel, aluminum, etc.), thereby providing rigidity and strength to this transparent or semi-transparent wall. Mesh 14 has edges (concealed in FIG. 1) which are coupled to frame 12. The edges of mesh 14 are coupled to frame 12 with nails, staples, glue, welds, or other suitable fasteners. These edges are jagged, sharp, and/or pointed. Other non-ferrous mesh materials may have similar jagged edges to which the present invention would be applicable. To conceal at least a portion of one edge, or all of the edges in this exemplary embodiment, protective molding 16 is provided.

Protective molding 16 is configured to cover or conceal at least a portion of an edge of mesh 14. Protective molding 16 may be non-ferrous or non-metallic, and may be any protective substance. Suitable compositions include plastics, rubbers, certain graphite compositions, polymers, polyethylene, polyvinyl chloride (PVC), polypropylene, and nylon or any other compositions suitable for the present use. Non-ferrous, protective molding 16 is manufactured in strips by a molding process, such as, pouring, casting, extruding, injection molding, etc. The strips may be between one-quarter inch wide and three or more inches wide, but are preferably between three-quarters of an inch and one-inch wide. Non-ferrous, protective molding 16 is advantageously one or more of the following: splinter-free, break-proof, inexpensive, appropriate for use by children, cosmetically and aesthetically pleasing, available in a variety of colors, textures and patterns, easily shaped for curved, contoured, and kinked surfaces, and variable in terms of hardness or stiffness. While several suitable compositions are expressly recited herein, other equivalent materials may be utilized.

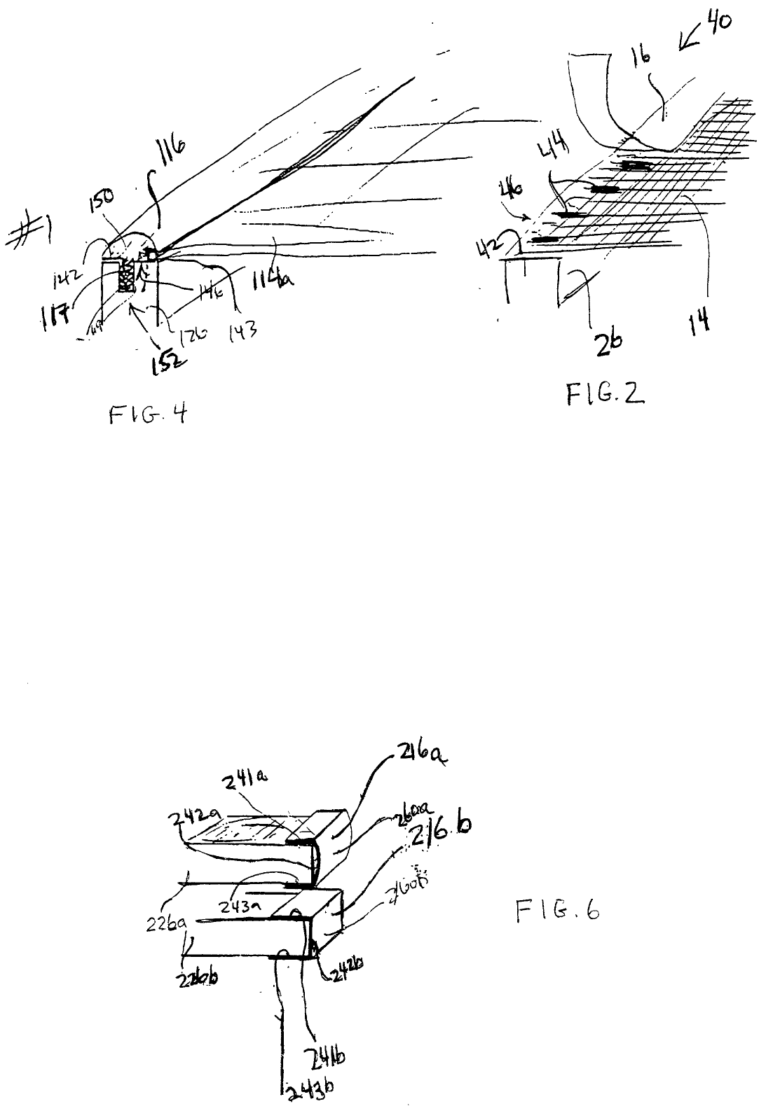

Referring now to FIG. 2, a portion 40 of device 10 is shown in greater detail and will now be described. Mesh 14, having a jagged edge 46, is applied over an edge 42 of rear wall 26. Next, a plurality of fasteners 44 are applied to couple mesh 14 to edge 42. In this exemplary embodiment, fasteners 44 are staples. Fasteners 44 preferably are configured to (i.e., have the necessary structure and sufficient durability to) couple mesh 14 to rear wall 26 without any additional forces. Fasteners 44 may be of any number, from two or three to many more or may include glue or welds. Next, non-ferrous, protective molding 16 is applied over ferrous wire mesh 14 to cover jagged edge 46 and/or fastener 44. As mentioned, non-ferrous, protective molding 16 is not needed to hold mesh 14 in place in this exemplary embodiment since fasteners 44 perform said function adequately.

Non-ferrous, protective molding 16 is then secured to rear wall 26 and/or mesh 14. As shown in FIG. 1, non-ferrous protective molding 16 advantageously requires a fewer number of fasteners 48, for example, two in this example: one on each side of rear wall 26, thus contributing to the aesthetic appeal of device 10. Other edges of mesh 14 are coupled in a similar manner to front wall 24 and base wall 22. Similarly, only a few fasteners 49, 50 are required for front wall 24 and base wall 22, respectively (or a small amount of a fastener, such as a glue).

As mentioned, many alternative configurations flow naturally from the teachings herein. For example, FIG. 3 discloses one alternative embodiment as device 110. Device 110 is similar to device 10 in many respects, but includes several modifications. For example, device 110 includes a first mesh 114a and a second mesh 114b, separated from one another by frame 112 having four walls: base wall 122, front wall 124, rear wall 126, and top wall 127. Meshes 114a and 114b are ferrous in this exemplary embodiment. All of walls 122-127 are parallelogram in shape and, more particularly, are rectangular in shape. Furthermore, a circular door 120 is detachable from frame 112 and operates by interference fit within an aperture 134 of frame 112. Circular door 120 is fabricated from a hard, resilient substance, such as plastic or wood. Also, a handle 118 is coupled to the sides of walls 124, 126 rather than the tops of the walls 24, 26 as with handle 18. Each of screens 114a, 114b is coupled to walls 122-127 with fasteners similar to those described with reference to FIG. 2.

Referring now to FIG. 4, a view of a portion of device 110 is shown, disclosing an alternative structure for non-ferrous, protective molding 116. In this embodiment, molding 116 includes a protrusion 117 running substantially the length of molding 116, such that the cross-sectional view of non-ferrous, protective molding 116 is substantially “T”-shaped or “mushroom”-shaped. In this embodiment, mesh 114a (e.g., a ferrous mesh) extends only a portion of the way across a top surface 142 of rear wall 126. Specifically, jagged edge 146 of mesh 114a extends from an inside edge 143 of rear wall 126 to, but not beyond, protrusion 117. Alternatively, jagged edge 146 may extend completely across top surface 142. Jagged edge 146 is fastened to top surface 142 as described with reference to FIG. 2 (i.e., staples, nails, glue, etc.), and then non-ferrous, protective molding 116 is applied over at least a portion of jagged edge 146. Protrusion 117 includes rough edges 119 for frictionally engaging an inner surface 150 of a notch 152 which runs substantially the length of rear wall 126. Inner surface 150 may further include a rough surface 151 for engagement with protrusion 117, as shown in FIG. 5. It can be seen in the embodiment of FIG. 4 that no external fasteners, such as fasteners 48, 49, 50 are required to retain molding 116 to 126. This reduces manufacturing costs and provides a more aesthetic appearance.

In the embodiment of FIG. 3, one protective molding is provided over each of the edges where meshes 114a, 114b are coupled to front and rear walls 124, 126. Additional non-ferrous protective moldings are provided where meshes 114a, 114b couple to top wall 127 and bottom wall 122.

Referring now to FIG. 6, other alternative configurations of the protective molding are shown. In these embodiments, non-ferrous protective moldings 216a, 216b are substantially “U”-shaped in cross-section. This U-shape allows the non-ferrous, protective moldings 216a, 216b to frictionally engage rear walls 226a, 226b on three sides, front sides 241a and 241b, top sides 242a and 242b, and rear sides 243a and 243b. In these embodiments, no fasteners are required to retain moldings 216a, 216b to walls 226a, 226b, respectively, and the protrusion 117 of the embodiment of FIG. 4 is also not required. Molding 216a includes a surface 260a which is somewhat wider than top surface 242a of rear wall 226a, thereby creating a small air pocket between top surface 242a land surface 260a. This air pocket provides an aesthetic appearance different from that of molding 216b, in which top surface 242b is approximately the same width as surface 216b.

While the embodiments illustrated in the FIGs. and described above are presently preferred, it should be understood that these embodiments are offered by way of example only. For example, the frame may be of any size or shape, and may even be a window, door, or ventilation frame which may or may not define and enclosure therein in alternative embodiments. The mesh may have several separate portions (e.g., “windows”) coupled to the frame and not all edges of all portions need be constructed as disclosed here. Also, the present invention may be applied to other non-ferrous mesh screens which nonetheless have jagged edges. The invention is not limited to a particular embodiment, but extends to various modifications that nevertheless fall within the scope of the appended claims.

What is claimed is:

1. A device for holding objects to be observed, comprising:
a frame forming a portion of an enclosure;
a ferrous mesh forming another portion of the enclosure having an edge coupled to the frame;
a fastener configured to couple the edge to the frame; and
a non-ferrous, protective molding extending over the edge and positioned to conceal at least a portion of the edge.

2. The device of claim 1, wherein the non-ferrous, protective molding is formed by an extrusion process.

3. The device of claim 1, wherein the non-ferrous, protective molding is formed by injection molding.

4. The device of claim 1, wherein the non-ferrous, protective molding is a plastic.

5. The device of claim 1, wherein the protective molding is T-shaped in cross-section.

6. The device of claim 5, wherein the protective molding includes a protrusion, wherein the frame includes a recess, wherein the protrusion is frictionally engaged within the recess.

7. The device of claim 1, wherein the frame includes a first surface coupled to the edge, and a second surface coupled to a second edge of the ferrous mesh.

8. A device for holding objects to be observed, comprising:
a frame;
a mesh coupled to the frame, the frame and mesh defining portions of an enclosure, the mesh having a jagged edge;
a fastener configured to couple the jagged edge to the frame; and
a protective molding extending over at least a portion of the jagged edge.

9. The device of claim 8, wherein the protective molding is non-ferrous.

10. The device of claim 8, wherein this protective molding includes a plastic.

11. The device of claim 8, further comprising an aperture in a first portion of the frame and a door movable between an open and a closed position with respect to the aperture.

12. The device of claim 8, wherein the protective molding is a strip of molded or extruded material having a width of less than three inches.

13. The device of claim 8, wherein the protective molding is U-shaped in cross section.

14. A method of providing a device for holding objects to be observed, comprising:
providing a frame;
fastening a first edge of a mesh material to a first portion of the frame;
fastening a second edge of the mesh material to a second portion of the frame, wherein the mesh material is securely fastened to the frame; and
providing a non-ferrous molding over the first edge of the mesh material.

15. The method of claim 14, further comprising providing a second non-ferrous molding over the second edge of the mesh material.

16. The method of claim 14, wherein the non-ferrous molding is formed by an extrusion process or an injection molding.

17. The method of claim 14, wherein the non-ferrous molding includes a strip of molding having a width of less than three inches.

18. A device for holding objects to be observed, comprising:
first means for forming a portion of an enclosure;
mesh means for forming another portion of the enclosure;
means for coupling the mesh means to the first means; and
means for concealing at least a portion of the means for coupling.

19. The device of claim 18, wherein the mesh means includes a ferrous mesh having a jagged edge.

20. The device of claim 19, wherein the means for concealing includes a non-ferrous, protective molding, wherein the means for concealing further conceals the jagged edge.
